(19) United States
(12) Patent Application Publication
(10) Pub. No.: US 2021/0002124 A1
(43) Pub. Date: Jan. 7, 2021

(54) FUEL MIXING DEVICES AND METHODS OF USE

(71) Applicant: Global Engineering Solutions Limited, East Wan Chai (HK)

(72) Inventor: Shayne LOWRIE, Alberta (CA)

(73) Assignee: Global Engineering Solutions Limited, East Wan Chai (HK)

(21) Appl. No.: 16/460,316

(22) Filed: Jul. 2, 2019

(51) Int. Cl. B67D 7/74; F02M 37/00; F02M 31/20; B01F 3/08; B01F 15/06; B67D 7/04

(52) U.S. Cl. CPC B67D 7/74; F02M 37/007; F02M 31/20; F02M 37/0052; B01F 2015/061; B01F 3/0865; B01F 15/066; B67D 7/04; F02M 37/0088

(57) ABSTRACT

A fuel mixer includes a first compartment, a second compartment, a third compartment, a plurality of cooling tubes, and at least one flow pipe. The second compartment is in fluid communication with the first compartment and is at least partially above the first compartment. The third compartment is in fluid communication with the first compartment and is at least partially above the first compartment. The plurality of cooling tubes are disposed in the second compartment and extend between the first compartment and the third compartment, thereby allowing fuel to flow from the first compartment to the third compartment. The at least one flow pipe is disposed in the second compartment and has an open top end, thereby allowing fuel to flow from the second compartment to the first compartment.

### BACKGROUND

Various types of machinery used at worksites need to be operated continuously over an extended period of time. Where the machinery is powered by a combustion engine with fuel supplied from a fuel tank with limited capacity, it may be necessary to refuel the machinery's fuel tank during the machinery's continued operation in order to prevent the fuel tank from running empty. Where worksites have multiple pieces of machinery running simultaneously, multiple fuel tanks may require refueling at the same time. Various systems for refueling these local fuel tanks have been developed.

However, when refilling these local tanks from a remote location, there is a risk that the tanks will be overfilled, potentially leading to a fire.

### SUMMARY

In one aspect, a fuel mixer includes a first compartment, a second compartment, a third compartment, a plurality of cooling tubes, and at least one flow pipe. The second compartment is in fluid communication with the first compartment and is at least partially above the first compartment. The third compartment is in fluid communication with the first compartment and is at least partially above the first compartment. The plurality of cooling tubes are disposed in the second compartment and extend between the first compartment and the third compartment, thereby allowing fuel to flow from the first compartment to the third compartment. The at least one flow pipe is disposed in the second compartment and has an open top end, thereby allowing fuel to flow from the second compartment to the first compartment.

In another aspect, a refueling system includes a fuel source supplying fuel at a source temperature and a fuel mixer. The fuel mixer includes a first compartment, a second compartment, a third compartment, and cooling tubes. The first compartment is fluidly coupled to an engine of a piece of fracking machinery supplying fuel at a return temperature to the fuel mixer, the return temperature greater than the source temperature. The second compartment is in fluid communication with the first compartment and fluidly coupled to the fuel source. The third compartment is in fluid communication with the first compartment. The cooling tubes are disposed in the second compartment and extend between the first compartment and the third compartment. During operation, fuel from the fuel source at least partially fills the second compartment and flows from the second compartment to the first compartment to mix with the fuel from engine such that fuel in the first compartment is at a mixed temperature that is intermediate the supply and return temperatures. The fuel from the first compartment flows through the cooling tubes to the third compartment and is further cooled such that the fuel in the third compartment is at a cooled temperature that is lower than the mixed temperature.

In another aspect, a method of refueling fracking equipment includes introducing a first fuel received from an engine of the fracking equipment to a first compartment of a fuel mixer, the first fuel at a first temperature. The method further includes filling, at least partially, a second compartment of the fuel mixer with a second fuel received from a fuel source, the second fuel at a second temperature lower than the first temperature. The method further includes mixing the first fuel and the second fuel in the first compartment. The method further includes passing the mixed fuel through cooling tubes disposed in the second compartment. The method further includes delivering the mixed fuel to the engine of the fracking equipment.

### BRIEF DESCRIPTION OF DRAWINGS

The features of the embodiments described herein will be more fully disclosed in the following detailed description, which is to be considered together with the accompanying drawings wherein like numbers refer to like parts and further wherein:

FIG. 1 shows a prior art refueling system.

FIG. 2 shows a refueling system according to one embodiment described herein.

FIG. 3 shows a front perspective view of a fuel source selection device according to one embodiment described herein.

FIG. 4 shows a front view of the fuel source selection device of FIG. 3 with the faceplate removed and the body transparent to show the internal features of the fuel mixer.

FIG. 5 is a front perspective view of the fuel source selection device of FIG. 3 with the faceplate removed and the body transparent to show the internal features of the fuel mixer.

FIG. 6A shows a cross-sectional perspective view of the fuel source selection device of FIG. 3, with the diverter valve in a first configuration.

FIG. 6B shows a cross-sectional perspective view of the fuel source selection device of FIG. 3, with the diverter valve in a second configuration.

FIG. 7 is another cross-sectional perspective view of the fuel source selection device of FIG. 3.

FIG. 8 is another cross-sectional perspective view of the fuel source selection device of FIG. 3.

FIG. 9 is a rear perspective view of the fuel source selection device of FIG. 3.

FIG. 10 is a perspective view of the fuel source selection device of FIG. 3 mounted to a stand.

### DETAILED DESCRIPTION

This description of the exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

The fuel source selection devices and fuel mixers described herein can be used in a variety of applications. For example, they can be used to refuel machinery used in hydraulic fracturing. The fuel source selection device may allow an operator to select whether to refuel the machinery from a local fuel tank or, alternatively, directly fuel the machinery using a centralized refueling system configured to supply fuel to multiple pieces of equipment simultaneously. For example, the fuel source selection devices described herein can be used with the OCTOFUELER automated frac refueling system supplied by Global Engineering Solutions. Such centralized refueling systems allow for the safe refueling of multiple pieces of equipment without requiring a user to enter the “hot zone” where risk of injury is significantly increased. The fuel source selection devices described herein allow for the direct fueling of the machinery from the centralized fueling system, bypassing the machinery's local fuel tank. This reduces the risk of overfilling the local fuel tank and causing a spill.

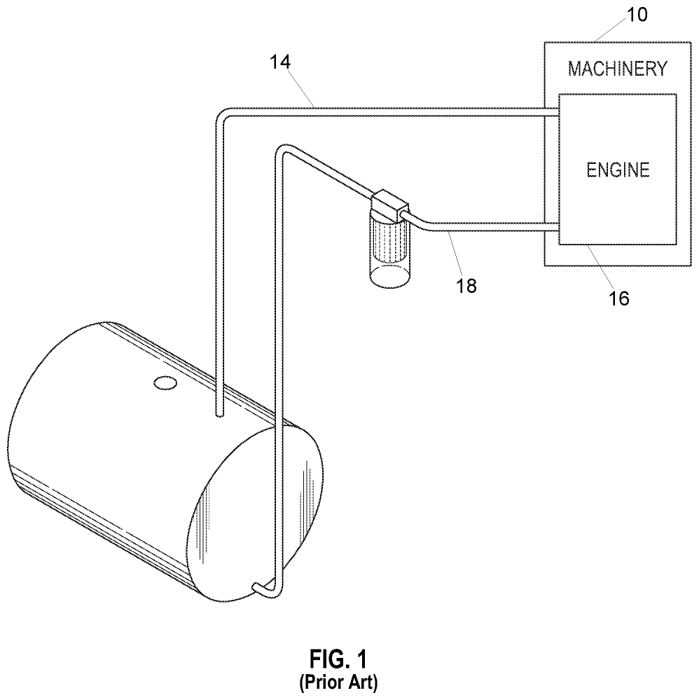

During the operation of typical diesel machinery used in the hydraulic fracturing process, only a portion of the fuel supplied to the engine is used during the combustion cycle. The remainder of the fuel is circulated through various portions of the engine to cool the engine and maintain its operating temperature. Typically, as shown in FIG. 1, unused fuel, now at an elevated temperature, is returned to the machinery 10's fuel tank 12 via return hose 14 for subsequent use. Fuel is then supplied to engine 16 via supply hose 18. In contrast, the fuel mixers described herein allow for the efficient mixing of this hot return fuel with freshly supplied fuel such that the engine can be continuously fueled while bypassing the local fuel tank.

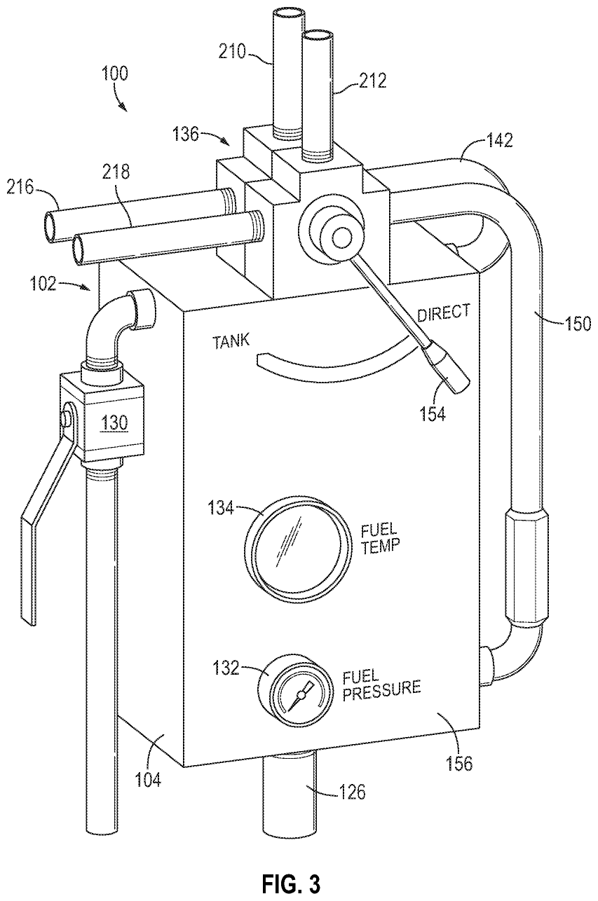

In one embodiment, shown in FIGS. 3-10, a fuel source selection device 100 includes a fuel mixer 102. Fuel mixer 102 includes a body 104 defining a mixing chamber 106. Body 104 may be constructed using any appropriate method and materials. For example, in one embodiment, body 104 is constructed by welding steel or aluminum. In other embodiments, body 104 is formed at least partially using a casting process.

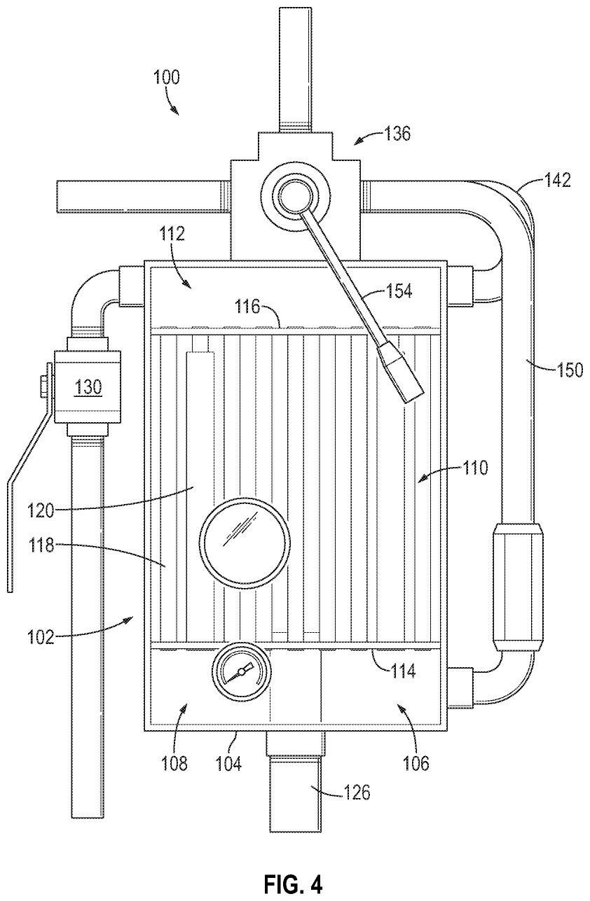

Turning to FIG. 4, mixing chamber 106 includes a first compartment 108, a second compartment 110, and a third compartment 112. Second compartment 110 is in fluid communication with first compartment 108. In various embodiments, second compartment 110 is at least partially above first compartment 108. Third compartment 112 is also in fluid communication with first compartment 108. In various embodiments, third compartment 112 is at least partially above first compartment 108. In some embodiments, third compartment 112 is at least partially above second compartment 110. As will be described in further detail herein, the relative position of the respective compartments may allow fuel to flow from one compartment to another to allow mixing and, optionally, cooling of hot fuel returned from an engine of a piece of equipment or machinery.

In one embodiment, first compartment 108, second compartment 110, and third compartment 112 are stacked vertically, one on top of another. In such embodiments, first compartment 108 and second compartment 110 may be separated by a first bulkhead 114. Further, second compartment 110 and third compartment 112 may be separated by a second bulkhead 116. First bulkhead 114 and second bulkhead 116 may be constructed of any appropriate material. For example, first bulkhead 114 and second bulkhead 116 may be constructed of aluminum, steel, stainless steel, or any other appropriate material. The bulkheads 114, 116 can be joined to body 104 using any appropriate method. For example, in one embodiment, bulkheads 114, 116 are welded to body 104. In various embodiments, the perimeters of bulkheads 114, 116 are sealed to body 104 such that fuel cannot flow from one compartment to another around the perimeter of bulkheads 114, 116. For example, the perimeters of bulkheads 114, 116 can be sealed using a gasket, adhesive, caulk, or any other appropriate material.

First compartment 108, second compartment 110, and third compartment 112 can have any appropriate geometries. In various embodiments, second compartment 110 has a height that is greater than the height of either first compartment 108 or second compartment 110. This allows for increased heat transfer, as will be described further herein. Further, first compartment 108, second compartment 110, and third compartment 112 may have any appropriate volumes. In some embodiments, the volume of second compartment 110 is greater than the volume of either first compartment 108 or third compartment 112.

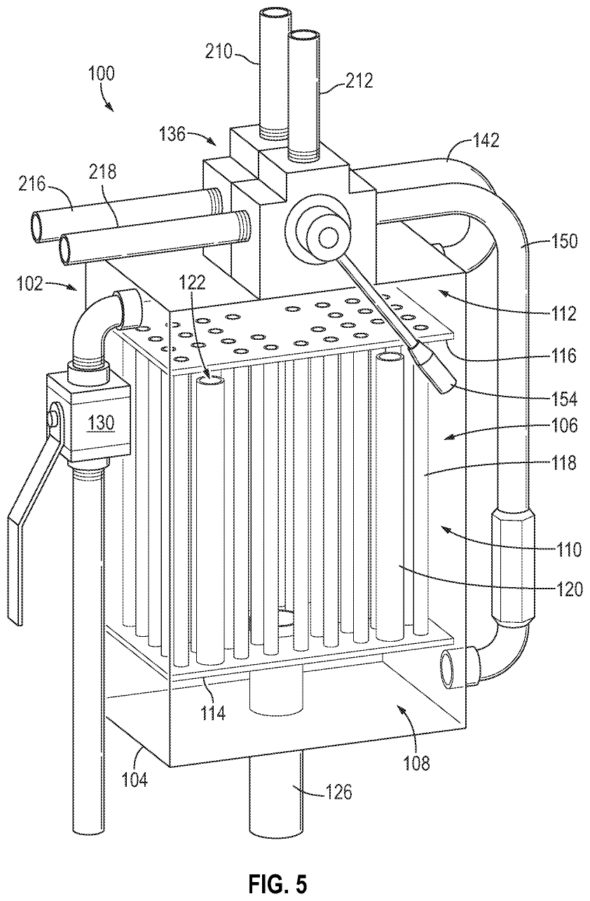

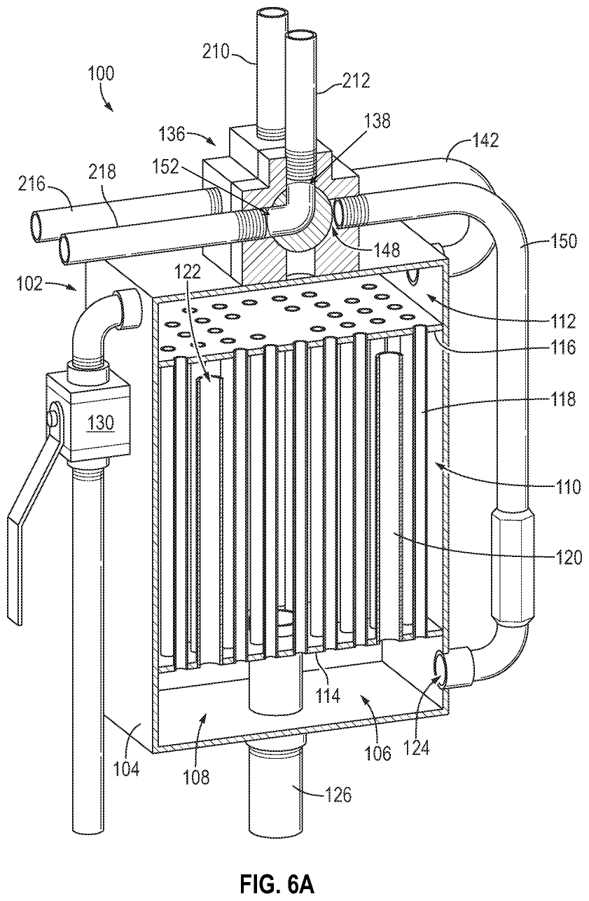

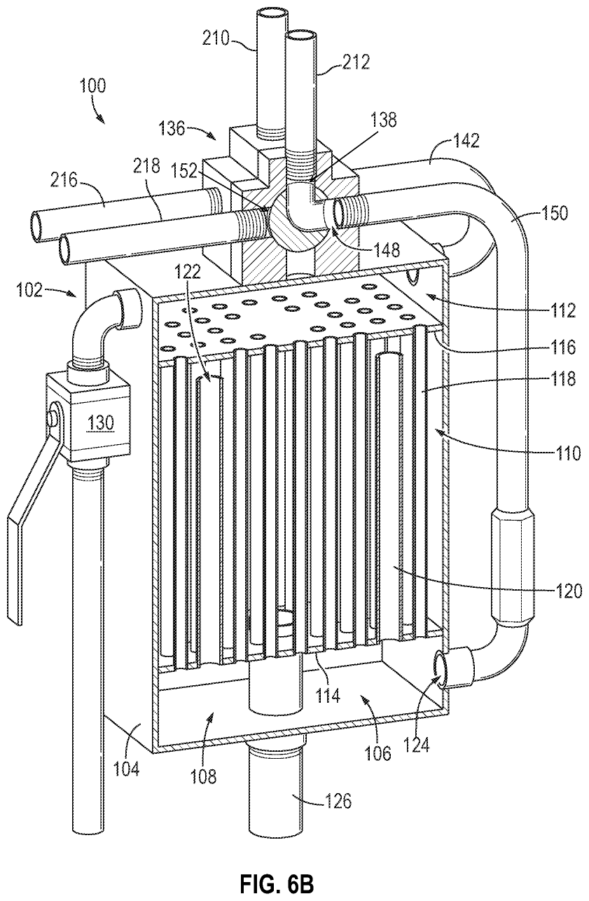

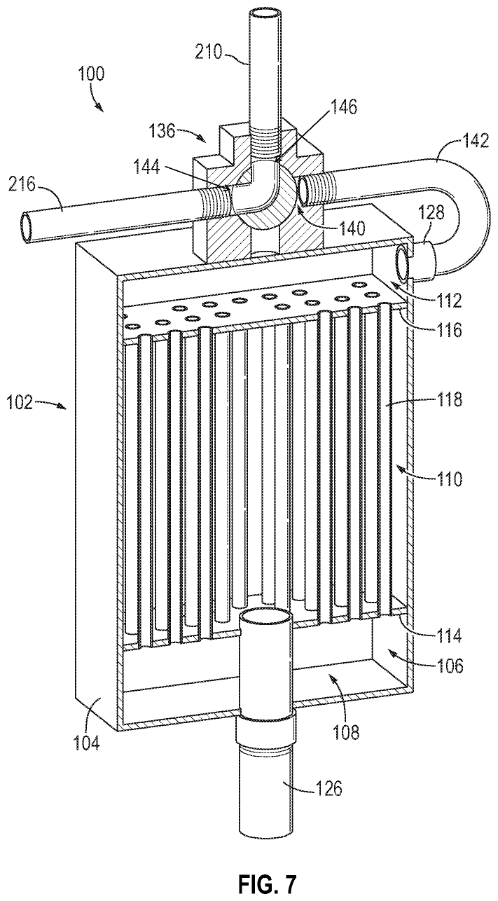

As best shown in FIGS. 5, 6A, and 6B, in various embodiments, fuel mixer 102 further includes at least one cooling tube 118 and at least one flow pipe 120. Cooling tubes 118 are disposed in second compartment 110 and extend between first compartment 108 and third compartment 112. As shown, for example, in FIG. 7, cooling tubes 118 are open on both ends to allow fuel to flow from first compartment 108 to third compartment 112. Cooling tubes 118 are configured to allow the conduction of heat through their walls such that, during operation, fuel flowing through cooling tubes 118 is cooled. In various embodiments, as shown in FIG. 7, cooling tubes 118 are maintained in position by first bulkhead 114 and second bulkhead 116. Cooling tubes 118 can have any appropriate inner diameter. Further, cooling tubes 118 can have any appropriate wall thickness.

Flow pipes 120 are disposed in second compartment 110 and have an open top end 122 within second compartment 110. As will be described further herein, during operation, fuel in second compartment 110 flows through open top end 122, through flow pipe 120, and into first compartment 108. Flow pipes 120 may have any appropriate length. Further, flow pipes 120 may have any appropriate inner diameter. In various embodiments, the inner diameter of flow pipes 120 is greater than the inner diameter of cooling tubes 118.

As shown, for example, in FIGS. 6A, 6B, and 7, fuel mixer 102 further includes a first mixer inlet 124, a second mixer inlet 126, and a mixer outlet 128. First mixer inlet 124 is in fluid communication with first compartment 108. Second mixer inlet 126 is in fluid communication with second compartment 110. Mixer outlet 128 is in fluid communication with third compartment 112. As will be described in further detail herein, first mixer inlet 124 is configured to allow passage of hot return fuel from an engine of a piece of equipment into first compartment 108. Further, second mixer inlet 126 is configured to allow passage of fuel from a fuel source into second compartment 110. Mixer outlet 128 is configured to allow mixed fuel in third compartment 112 to exit the fuel mixer 102 and be returned to the engine.

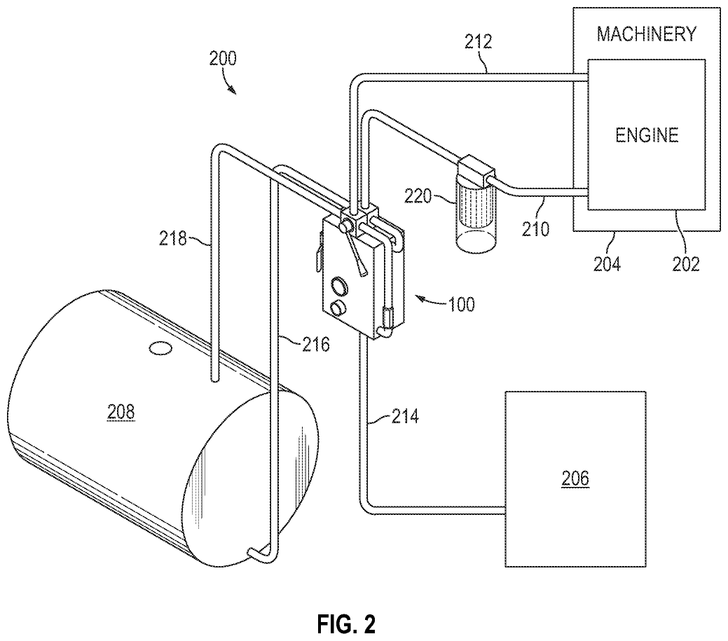

As shown in FIG. 2, fuel source selection device 100 can be integrated into a refueling system 200 configured to fuel an engine 202 of a piece of machinery 204. Refueling system 200 further includes a fuel source 206 and a local fuel tank 208. When fuel source selection device 100 is installed in refueling system 200, first compartment 108 of mixing chamber 106 is fluidly coupled, via first mixer inlet 124, to engine 202. Further, second compartment 110 is fluidly coupled, via second mixer inlet 126, to fuel source 206.

The fuel supplied by fuel source 206 is at a source temperature, Ts. Engine 202 supplies fuel to fuel mixer 102 at a return temperature, TR. The return temperature, TR, being greater than the source temperature, Ts.

During operation, fuel from fuel source 206 at least partially fills second compartment 110 and flows into open top end 122 of flow pipe 120, through flow pipe 120, and into first compartment 108 where it mixes with the fuel from engine 202. The fuel within first compartment 108 is, therefore, at a mixed temperature that is intermediate the source, Ts, and return, TR, temperatures. Further, the fuel from first compartment 108 flows through cooling tubes 118 to third compartment 112. Cooling tubes 118 are surrounded by fuel at the source temperature. Hence, as the fuel flows through cooling tubes 118 it is further cooled such that the fuel in third compartment 112 is at a cooled temperature that is lower than the mixed temperature.

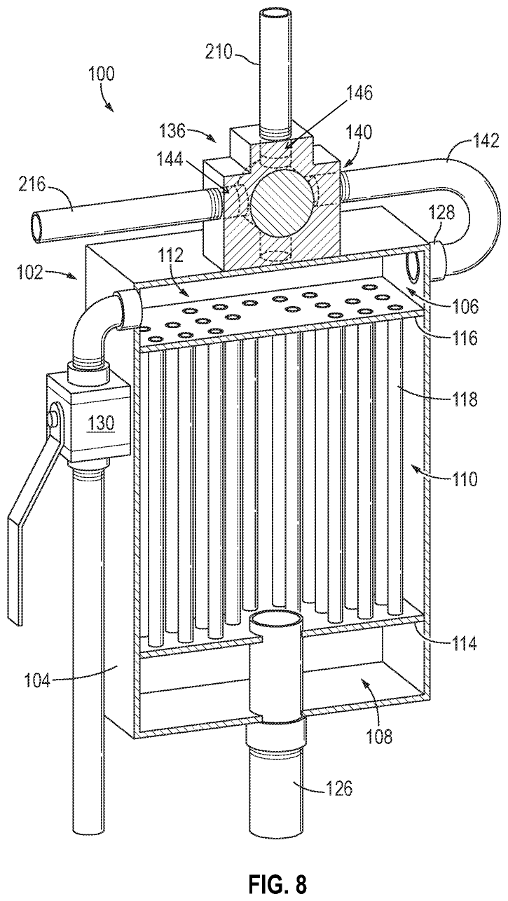

In one embodiment, fuel mixer 102 also includes a purge valve 130 configured to allow air to exit mixing chamber 106. As shown best in FIG. 8, purge valve 130 may be fluidly coupled to third compartment 112. During operation, air exits third compartment 112 through purge valve 130 so that mixing chamber 106 can continue receiving fuel from engine 202 and fuel source 206.

The fuel mixer 102 may further include various gauges. For example, as shown in FIG. 3, fuel mixer 102 may include a fuel pressure gauge 132 and a fuel temperature gauge 134. This may allow a user to, for example, ensure that the temperature of the fuel in mixing chamber 106 is below an acceptable temperature. The fuel temperature gauge 134 may reflect the temperature of the fuel in any of the compartments of mixing chamber 106. For example, in one embodiment, fuel temperature gauge 134 reflects the temperature in first compartment 108. In another embodiment, fuel temperature gauge 134 reflects the temperature in second compartment 110. In yet another embodiment, fuel temperature gauge 134 reflects the temperature in third compartment 112. In various embodiments, fuel mixer 102 includes multiple fuel temperature gauges, each reflecting the temperature of the fuel in a different compartment of mixing chamber 106. Further, in various embodiments, fuel mixer 102 may include instrumentation that allows the temperature and/or pressure in mixing chamber 106 to be remotely monitored. For example, fuel mixer 102 may include instruments that are in communication with a central control station. In such embodiments, the temperature and pressure of multiple fuel mixers may be monitored from one location. The instrumentation may be physically coupled (e.g., via wires) or wirelessly coupled (e.g., via WiFi, Bluetooth, cellular, RFID, NFC, or other form of communication). In one embodiment, the central control station is movable (e.g., a smartphone, tablet, or laptop computer).

In various embodiments, the fuel source selection device 100 further includes one or more valves that allow a user to control whether fuel is supplied to engine 202 from fuel source 206 or local fuel tank 208. As will be described herein, fuel source selection device 100 is configured to operate in either a first mode, in which fuel is supplied from fuel source 206 to engine 202, or a second mode, in which fuel is supplied from local fuel tank 208 to engine 202.

For example, as shown in FIG. 2, refueling system 200 may include an engine supply hose 210 coupled to fuel source selection device 100 and engine 202 to supply fuel to engine 202. Refueling system 200 may further include an engine return hose 212 coupled to fuel source selection device 100 and engine 202 to return fuel from engine 202 to fuel source selection device 100. Refueling system 200 may further include a fuel source hose 214 fluidly coupling fuel source 206 and fuel source selection device 100. Refueling system 200 may further include a local fuel tank supply hose 216 fluidly coupling local fuel tank 208 and fuel source selection device 100 to carry fuel from local fuel tank 208 to fuel source selection device 100. Refueling system 200 may further include a local fuel tank filling hose 218 fluidly coupling fuel source selection device 100 and local fuel tank 208 to carry hot return fuel from engine 202 to local fuel tank 208.

When operating in the first mode of operation, the one or more valves of fuel source selection device 100 are configured such that engine supply hose 210 and fuel source hose 214 are in fluid communication (e.g., via mixing chamber 106). Further, in the first mode of operation, the one or more valves are configured such that engine return hose 212 is in fluid communication with mixing chamber 106 such that hot return fuel may mix with fuel from fuel source 206, as described above.

When operating in the second mode of operation, the one or more valves of fuel source selection device 100 are configured such that engine supply hose 210 and local fuel tank supply hose 216 are in fluid communication to supply engine 202 with fuel from local fuel tank 208. Further, in the second mode of operation, the one or more valves are configured such that engine return hose 212 is in fluid communication with local fuel tank filling hose 218 to supply hot return fuel from engine 202 to local fuel tank 208.

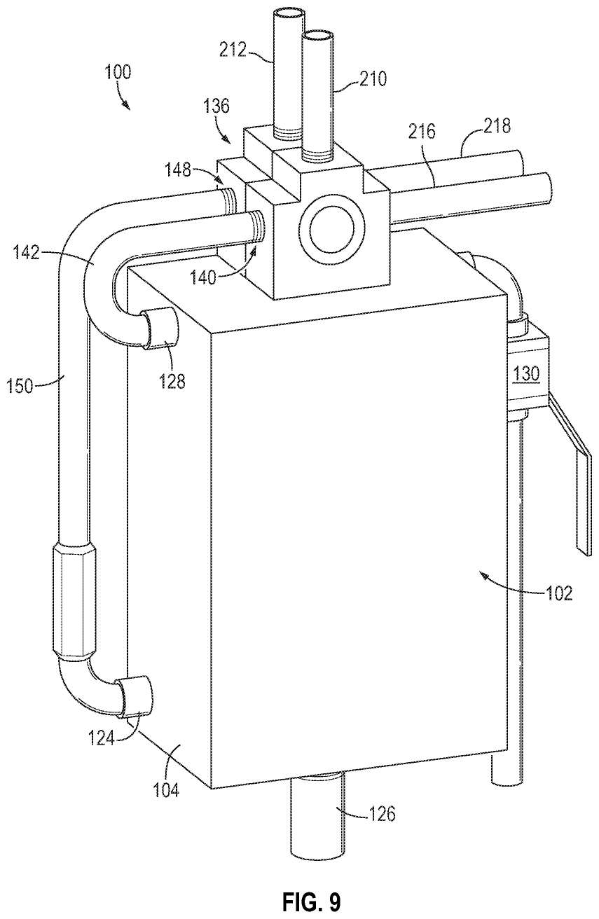

In at least one embodiment, fuel source selection device 100 includes a diverter valve 136, as shown in FIGS. 3-10. In various embodiments, diverter valve 136 is a six-way diverter valve. Diverter valve 136 has a first valve inlet 138 (shown for example in FIG. 6A) configured to be fluidly coupled to engine 202 by engine return hose 212, a second valve inlet 140 (shown for example in FIG. 7) fluidly coupled to third compartment 112 of mixing chamber 106 by a mixed fuel hose 142 (shown in FIG. 9), and a third valve inlet 144 (shown for example in FIG. 7) configured to be fluidly coupled to local fuel tank 208 by local fuel tank supply hose 216. Diverter valve 136 further includes a first valve outlet 146 (shown for example in FIG. 7) configured to be fluidly coupled to engine 202 by engine supply hose 210, a second valve outlet 148 (shown for example in FIG. 6A) fluidly coupled to first compartment 108 of mixing chamber 106 by a hot fuel hose 150, and a third valve outlet 152 (shown for example in FIG. 6A) configured to be fluidly coupled to local fuel tank 208 by local fuel tank filling hose 218.

When operating in the first mode, return fuel from engine 202 passes through first valve inlet 138 and out through second valve outlet 148 and into first compartment 108 of mixing chamber 106 via hot fuel hose 150 and first mixer inlet 124. In addition, fuel from fuel source 206 passes into second compartment 110 of mixing chamber 106 via fuel source hose 214 and second mixer inlet 126. As described above, the fuel from engine 202 and fuel source 206 mix in mixing chamber 106. The mixed fuel in third compartment 112 of mixing chamber 106 passes through mixer outlet 128, mixed fuel hose 142, second valve inlet 140, first valve outlet 146, and engine supply hose 210 to engine 202. This process continues as machinery 204 is operated.

As described above, when operating in the first mode, hot return fuel from engine 202 is not supplied to local fuel tank 208. Instead, the return fuel is continuously cooled and recycled via fuel mixer 102. This eliminates the risk of over-filling local fuel tank 208, thereby significantly reducing the risk of accidents or fires.

When operating in the second mode, return fuel from engine 202 passes through engine return hose 212, first valve inlet 138, third valve outlet 152, local fuel tank filling hose 218, and into local fuel tank 208 where the hot fuel from engine 202 is able to mix with the cooler fuel contained therein. In addition, fuel from the local fuel tank 208 passes through local fuel tank supply hose 216, third valve inlet 144, first valve outlet 146, local fuel tank supply hose 216, and to engine 202.

As a result, the user is able to select one of the fuel sources from which to supply fuel to engine 202 of machinery 204. Hence, fuel source selection device 100 may be permanently installed as a portion of the refueling system. When a central refueling source (e.g., fuel source 206) is being used, fuel source selection device 100 is used in the first mode of operation. When a central refueling source is not being used, fuel source selection device 100 is used in the second mode of operation. This allows for safe switching between multiple fuel sources.

Diverter valve 136 may include any appropriate fitting for connection to the various hoses. For example, diverter valve 136 may include quick-connect type fittings, threaded fittings, cam-and-groove fittings, or any other appropriate type of fitting.

In various embodiments, as shown in FIG. 3, fuel source selection device 100 includes an actuator 154 allowing the user to operate diverter valve 136 to select the mode of operation. Further, fuel source selection device 100 can include a faceplate 156 having labels associated with the first and second mode of operation to allow users to easily identify the currently selected mode of operation. For example, a label of “DIRECT” may be used to indicate the first mode of operation and a label of “TANK” may be used for the second mode of operation.

Diverter valve 136 can be any appropriate diverter valve. For example, in one embodiment, diverter valve 136 is a six-way closed center flow diverter valve. Diverter valve 136 may be operated by actuator 154. As shown in FIG. 6A, when actuator 154 is in the position in which fuel is delivered from local fuel tank 208, first valve inlet 138 is coupled to third valve outlet 152. Turning to FIG. 6B, when actuator 154 is in a position such that fuel is delivered from fuel source 206, first valve inlet 138 is coupled to second valve outlet 148. Diverter valve 136 also selectively couples either second valve inlet 140 or third valve inlet 144 to first valve outlet 146. A configuration in which third valve inlet 144 is coupled to first valve outlet 146 is shown in FIG. 7.

Alternatively, in other embodiments, fuel source selection device 100 includes multiple valves. For example, in one embodiment, a first valve may allow selection of whether engine supply hose 210 is in fluid communication with fuel source 206 (via fuel mixer 102) or with local fuel tank supply hose 216. Further, a second valve may allow selection of whether engine return hose 212 is in fluid communication with fuel mixer 102 or with local fuel tank filling hose 218. In such embodiments, a user may operate the first and second valves to change the mode of operation of fuel source selection device 100.

In at least one embodiment, refueling system 200 includes a pre-filter 220 in line with engine supply hose 210. Pre-filter 220 removes particulates and other foreign matter from the fuel before the fuel is supplied to engine 202.

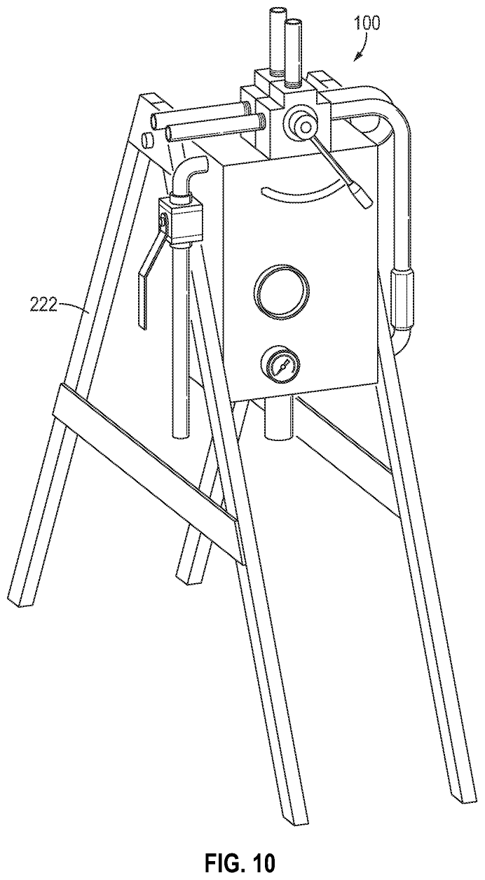

When installed, fuel source selection device 100 may be mounted directly to machinery 204. In other embodiments, fuel source selection device 100 may be mounted to a stand 222, as shown in FIG. 10.

The fuel source selection devices and fuel mixers described herein can be used to supply fuel to any type of machinery. For example, they can be used to supply machinery used in hydraulic fracturing such as pumpers, blenders, sand units, or any other appropriate machinery. Further, the fuel source selection devices and fuel mixers described herein can be used to supply any appropriate fuel to such machinery. For example, the fuel source selection devices and fuel mixers described herein can be used to supply diesel fuel. Alternatively, the fuel source selection devices and fuel mixers can be used to supply gasoline.

In various embodiments, a method of refueling fracking equipment includes introducing a first fuel received from engine 202 of machinery 204 to first compartment 108 of fuel mixer 102. The first fuel is at a return temperature. The method further includes filling, at least partially, second compartment 110 of fuel mixer 102 with a second fuel received from fuel source 206. The second fuel is at a source temperature that is lower than the return temperature. The method further includes mixing the first fuel and the second fuel in first compartment 108. The method further includes passing the mixed fuel through cooling tubes 118 disposed in second compartment 110. The method further includes delivering the mixed fuel to engine 202 of machinery 204 via third compartment 112 of fuel mixer 102.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention. All patents and published patent applications identified herein are incorporated herein by reference in their entireties.

We claim:

1. A fuel mixer, comprising:
a first compartment;
a second compartment in fluid communication with the first compartment, the second compartment at least partially above the first compartment;
a third compartment in fluid communication with the first compartment, the third compartment at least partially above the first compartment;
a plurality of cooling tubes disposed in the second compartment and extending between the first compartment and the third compartment, thereby allowing fuel to flow from the first compartment to the third compartment; and
at least one flow pipe disposed in the second compartment and having an open top end, thereby allowing fuel to flow from the second compartment to the first compartment.

2. The fuel mixer of claim 1, wherein the first compartment is configured to be fluidly coupled to a source of a first fuel, the second compartment is configured to be fluidly coupled to a source of a second fuel, and wherein, during operation the second fuel at least partially fills the second compartment and flows through the open top end of the at least one flow pipe and into the first compartment to mix with the first fuel, and the fuel from the first compartment flows through the plurality of cooling tubes to the third compartment.

3. The fuel mixer of claim 1, wherein the first compartment is separated from the second compartment by a first bulkhead and the second compartment is separated from the third compartment by a second bulkhead.

4. The fuel mixer of claim 1, wherein the plurality of cooling tubes have a smaller diameter than the at least one flow pipe.

5. The fuel mixer of claim 4, wherein the first compartment is separated from the second compartment by a first bulkhead and the second compartment is separated from the third compartment by a second bulkhead and wherein the plurality of cooling tubes are retained by the first bulkhead and the second bulkhead.

6. The fuel mixer of claim 1, wherein the second compartment is taller than either the first compartment or the third compartment.

7. The fuel mixer of claim 1, further comprising a purge valve configured to allow air to exit the third compartment.

8. The fuel mixer of claim 1, further comprising a temperature gauge to measure the temperature of the fuel within the first compartment, the second compartment, or the third compartment.

9. A refueling system, comprising:
a fuel source supplying fuel at a source temperature;
a fuel mixer, the fuel mixer comprising:
a first compartment fluidly coupled to an engine of a piece of fracking equipment supplying fuel at a return temperature to the fuel mixer, the return temperature greater than the source temperature;
a second compartment in fluid communication with the first compartment and fluidly coupled to the fuel source;
a third compartment in fluid communication with the first compartment; and
cooling tubes disposed in the second compartment and extending between the first compartment and the third compartment;
wherein, during operation, fuel from the fuel source at least partially fills the second compartment and flows from the second compartment to the first compartment to mix with the fuel from the engine such that fuel in the first compartment is at a mixed temperature that is intermediate the source and return temperatures; and
wherein the fuel from the first compartment flows through the cooling tubes to the third compartment and is further cooled such that the fuel in the third compartment is at a cooled temperature that is lower than the mixed temperature.

10. The refueling system of claim 9, wherein the second compartment is at least partially above the first compartment, and the third compartment is at least partially above the first compartment, and the fuel mixer further comprises at least one flow pipe disposed in the second compartment and having an open top end, such that fuel within the second compartment can pass through the open top end of the at least one flow pipe and into the first compartment.

11. The refueling system of claim 10, wherein the at least one cooling tube has a smaller diameter than the at least one flow pipe.

12. The refueling system of claim 10, wherein the second compartment is taller than either the first compartment or the second compartment.

13. The refueling system of claim 11, wherein the first compartment is separated from the second compartment by a first bulkhead and the second compartment is separated from the third compartment by a second bulkhead.

14. The refueling system of claim 13, wherein the plurality of cooling tubes are retained by the first bulkhead and the second bulkhead.

15. The refueling system of claim 10, wherein the fuel mixer further comprises a purge valve configured to allow air to exit the third compartment.

16. A method of refueling fracking equipment, comprising:
introducing a first fuel received from an engine of the fracking equipment to a first compartment of a fuel mixer, the first fuel at a return temperature;
filling, at least partially, a second compartment of the fuel mixer with a second fuel received from a fuel source, the second fuel at a source temperature lower than the return temperature;
mixing the first fuel and the second fuel in the first compartment;
passing the mixed fuel through a plurality of cooling tubes disposed in the second compartment; and
delivering the mixed fuel to the engine of the fracking equipment via a third compartment of the fuel mixer.

17. The method of claim 16, wherein the second compartment is at least partially above the first compartment, and the third compartment is at least partially above the second compartment, and the fuel mixer further comprises at least one flow pipe disposed in the second compartment and having an open top end, such that fuel within the second compartment can pass through the open top end of the at least one flow pipe and into the first compartment.

18. The method of claim 17, wherein the plurality of cooling tubes have a smaller diameter than the at least one flow pipe.

19. The method of claim 17, wherein the second compartment is taller than either the first compartment or the third compartment.
